(19) United States
(12) Patent Application Publication
(10) Pub. No.: US 2015/0096588 A1
(43) Pub. Date: Apr. 9, 2015

(54) ORAL HYGIENE KIT

(71) Applicants: Tom RESHEF, Rechovot (IL); Tom Benoliel, Rechovot (IL); Ortal Mazlawi, Ramle (IL)

(72) Inventors: Tom RESHEF, Rechovot (IL); Tom Benoliel, Rechovot (IL); Ortal Mazlawi, Ramle (IL)

(21) Appl. No.: 14/044,888

(22) Filed: Oct. 3, 2013

(51) Int. Cl. A45D 42/24; A61C 15/02

(52) U.S. Cl. CPC A45D 42/24; A61C 15/02
USPC 132/316; 53/445

(57) ABSTRACT

An oral hygiene kit, comprising: at least one toothpick (16); a mirror (14); and an envelope (12), enveloping the at least one toothpick and the mirror. Preferably, the mirror is stiff, and the length and width of the mirror are greater than the length and width of the at least one toothpick, thereby preventing a user from being jabbed by the toothpick before using the kit. Preferably, the envelope is sealed, thereby keeping the mirror and the at least one toothpick under hygienic conditions until use. Preferably, the length of the mirror is less than about 8 cm, for allowing holding thereof in a user's palm. Preferably, the width of the mirror is about between 1 and 2 cm, for providing a sufficient viewing area.

### FIELD OF THE INVENTION

The present invention relates to the field of oral hygiene. More particularly, the invention relates to an oral hygiene kit.

### BACKGROUND OF THE INVENTION

A toothpick is a small stick of wood, plastic, bamboo, metal, bone or other substance used to remove detritus from the teeth, usually after a meal. A toothpick has one or two sharp ends to insert between teeth. They can also be used for picking up small appetizers (such as cheese cubes or olives) or as a cocktail stick. (From Wikipedia)

When a toothpick is used for removing detritus, some may not be removed properly, remaining on the external side of the teeth of the user, which puts the user in an embarrassing situation. In order to be sure that no residues remain on teeth, the user must go to the rest room, and check things out in front of a mirror.

It is an object of the present invention to provide a solution to the above-mentioned and other problems of the prior art.

Other objects and advantages of the invention will become apparent as the description proceeds.

### SUMMARY OF THE INVENTION

An oral hygiene kit, comprising:
at least one toothpick (16);
a mirror (14);
a transparent envelope (12), hygienically enveloping the at least one toothpick and the mirror,
   thereby the at least one toothpick (16) and the transparent envelope (12) comprise together a handle for looking at the mirror (14), and
   thereby the looking at the mirror (14) is applied through the transparent envelope (12), and
   thereby the looking at the mirror (14) allows considering a one-time removal of the at least one toothpick (16) from the transparent envelope (12).

An oral hygiene kit, comprising:
at least one toothpick (16);
a mirror (14); and
an envelope (12), enveloping the at least one toothpick and the mirror.

Preferably, the mirror is of a stiff substance, and the length and width of the mirror are greater than the length and width of the at least one toothpick, thereby preventing a user from being jabbed by the toothpick before using the kit.

Preferably, the envelope is sealed, thereby keeping the mirror and the at least one toothpick under hygienic conditions until use.

According to one embodiment of the invention, the mirror is elongated, and the width thereof is about 1 cm, thereby providing a sufficient viewing area.

According to one embodiment of the invention, the mirror is flexible, thereby allowing bending thereof while holding the mirror in a user's palm, for widening a viewing area reflected from the mirror.

Preferably, the length of the mirror is less than about 8 cm, for allowing holding thereof in a user's palm.

Preferably, the width of the mirror is about between 1 and 2 cm, for providing a sufficient viewing area.

The envelope may be made of paper, nylon, cellophane, and so on, wherein cellophane is the preferred embodiment.

The mirror may be made of a member of a group comprising: coated glass, mirror wallpaper, tin foil, coated aluminum foil, plastic polymer, plastic polymer of DC FIX MIRROR, and so on.

According to one embodiment of the invention, the enveloping process of the kit comprises the steps of
dispensing a mirror (14) from a dispenser (32) thereof on a first foil from a first roller (28);
dispensing at least one toothpick (16) from a dispenser (34) thereof;
covering the mirror and the at least one toothpick (16) by a second foil from a second roller (30); and
soldering, by a soldering iron (36), the second foil to the first foil.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 pictorially illustrates an oral hygiene kit, according to one embodiment of the invention.

FIG. 2 pictorially illustrates a user's hand holding a mirror of an oral hygiene kit, according to one embodiment of the invention.

FIG. 3 pictorially illustrates a user using an oral hygiene kit, according to one embodiment of the invention.

FIG. 4 schematically illustrates an enveloping line of an oral hygiene kit, according to one embodiment of the invention.

FIG. 5 is a top view of the kit.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

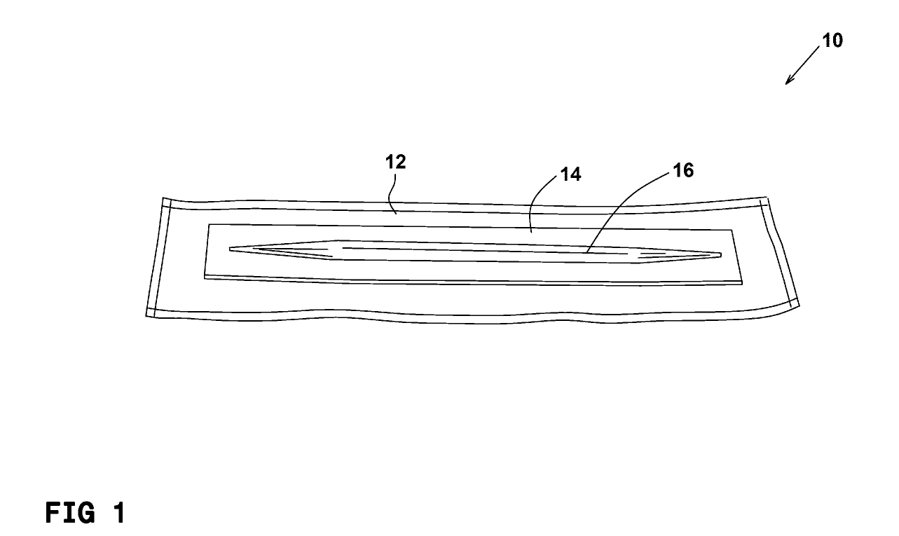

FIG. 1 pictorially illustrates an oral hygiene kit, according to one embodiment of the invention.

The kit comprises one or more toothpicks 16, and a mirror 14. The toothpicks and the mirror are enveloped in a sealed envelope 12.

The mirror may be made of flexible material, which allows bending thereof while holding thereof in a user's palm, thereby providing a wider viewing area.

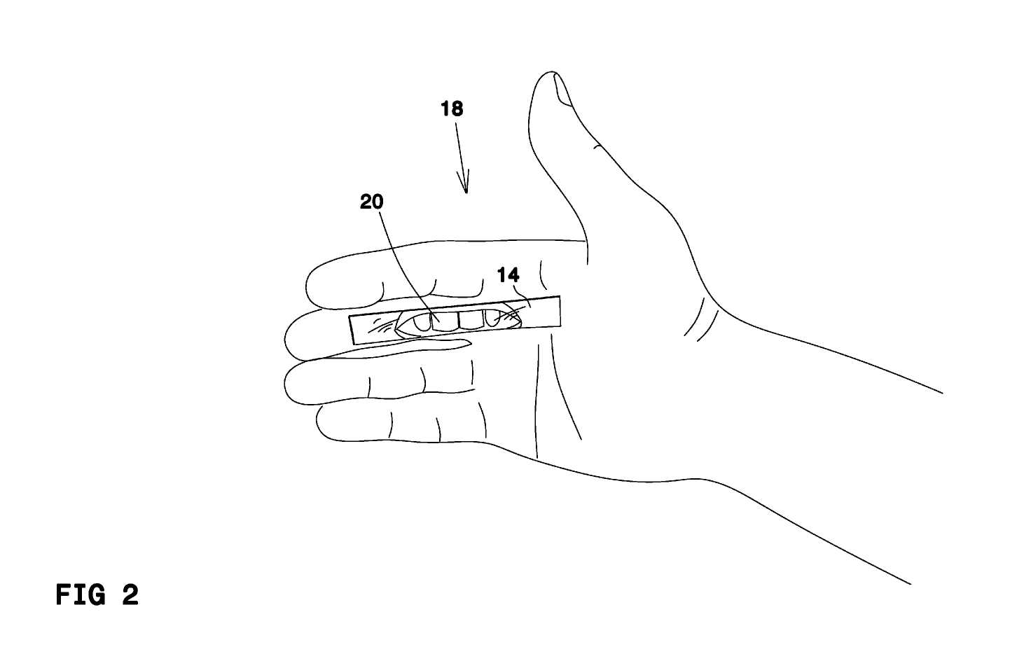

The length of the mirror enables holding the mirror in a user's palm, as illustrated in FIG. 2, by applying force on the edges of the mirror by slightly folding the palm.

The width of the mirror enables a user to see his teeth. More particularly, the width has to be about 1.5 cm to 2.5 cm.

The length of the mirror may be greater than the length of each of the toothpicks stored therein, in order to protect a user from being jabbed by the toothpicks.

The dimensions of the envelope are slightly greater than the dimensions of the mirror, in order to keep the toothpicks between the borders of the mirror, thereby preventing the tips thereof to outstand from the border of the mirror. In this way, the user is protected from being jabbed by the toothpicks. Nevertheless, in order to facilitate the structure of the kit, in FIG. 1 the dimensions of the envelope are substantially greater than the dimensions of the mirror.

The mirror may be made of coated glass, mirror wallpaper, tin foil, coated aluminum foil, plastic polymer such as of DC FIX MIRROR, and so on.

The envelope may be made of paper, nylon foil, cellophane, and so on. Preferably, the envelope is sealed, in order to keep its content sterile.

The envelope can be sealed by gluing, soldering, and so on.

Oral hygiene kits of the present invention may be distributed in a box, a dispenser, and so on.

A plurality of envelopes may be connected in a line, or distributed as separated.

The envelope may be vacuumed, in order to keep the toothpicks in the borders of the mirror.

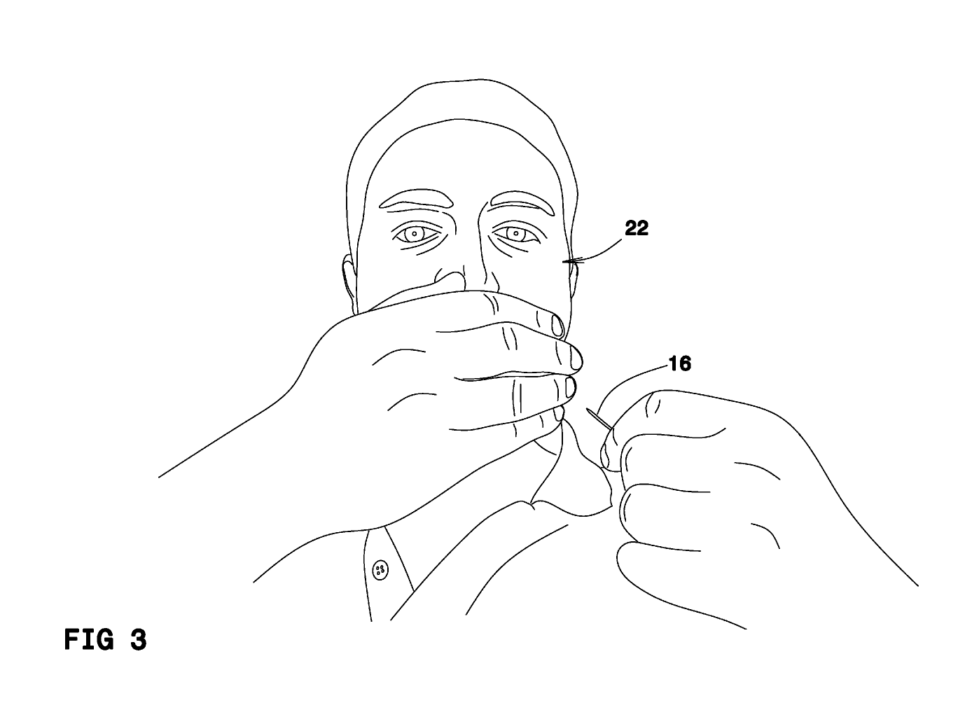

FIG. 3 pictorially illustrates a user using an oral hygiene kit, according to one embodiment of the invention.

User 22 holds in his right hand the mirror (not seen) of the kit, while removing detritus from his teeth with toothpick 16 by his left hand.

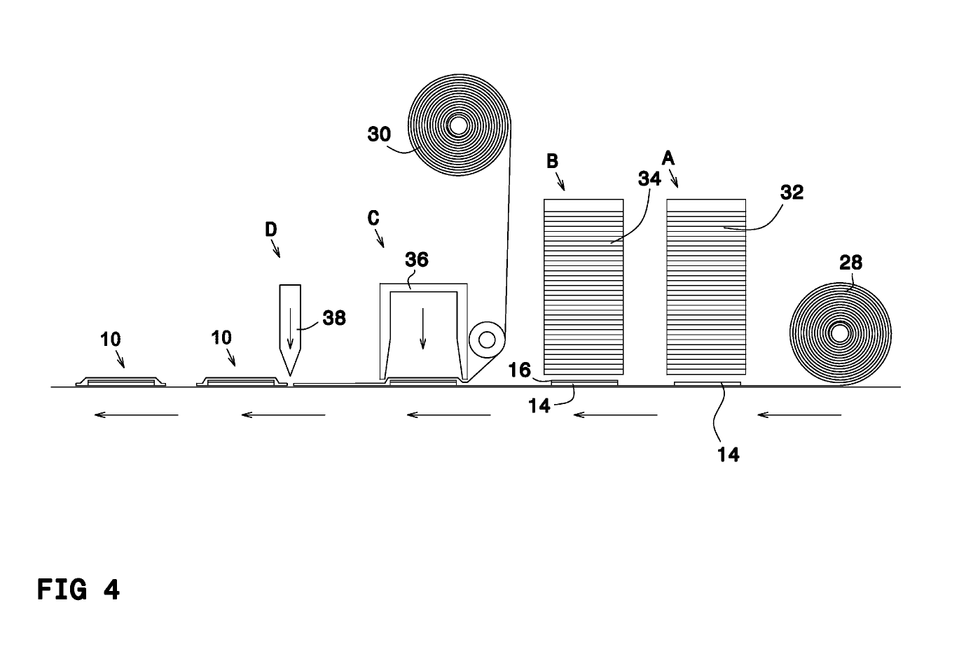

FIG. 4 schematically illustrates an enveloping line of an oral hygiene kit, according to one embodiment of the invention.

Rollers 28 and 30 are of a material from which the envelope is made, such as cellophane. Roller 30 is for an upper foil thereof, and roller 28 is for the lower roller thereof.

At stage (A), a mirror 14 is dispensed from a mirror dispenser 32 on a foil from roller 28. Then, the foil continues to roll, until mirror 14 reaches the next station.

At stage (B), which takes place at the next station, a toothpick is dispensed from toothpicks dispenser 34 on mirror 14. Then, the foil continues to roll, until mirror 14 reaches the next station.

At stage (C), which takes place at the next station, the upper foil (from roller 30) covers the mirror and the toothpick placed thereon. Then, soldering iron 36 solders the upper foil to the lower foil. Then, the foil continues to roll, until mirror 14 reaches the next station.

At stage (D), which takes place on the next station, a cutting machine 38 cuts the edges of the soldered envelope. Then, the foil continues to roll, until mirror 14 reaches the next station (not illustrated), on which the produced kits are stored in a pack.

Envelope 12 is transparent for looking at the mirror therethrough. Toothpick 16 and the transparent envelope 12 function together as a handle for looking at the mirror 14.

The user looks at the mirror 14, reviews the teeth, and considers whether to remove toothpick 16, since it is a one-time use item.

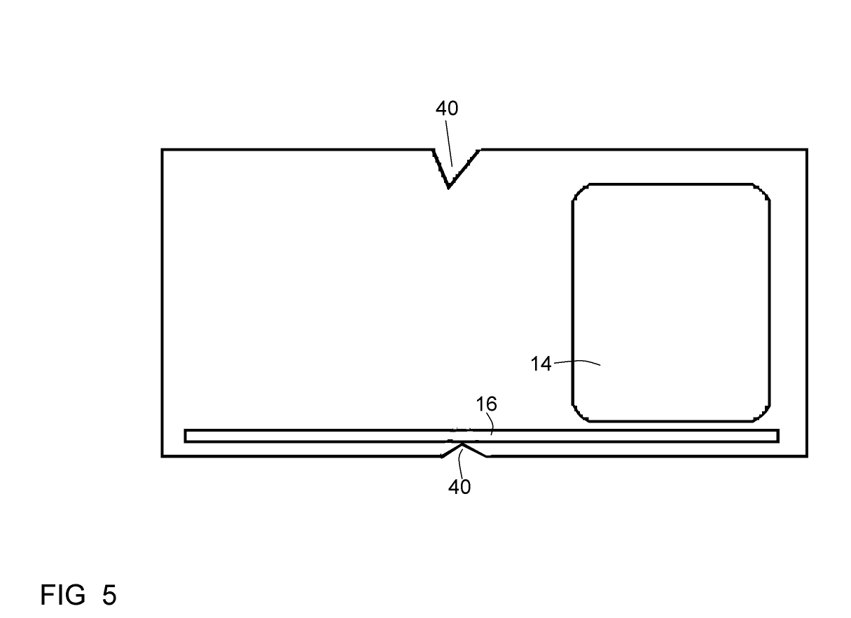

FIG. 5 is a top view of the kit.

Transparent envelope 12 preferably includes tearing edges 40, for neatly cutting envelope 12, for holding mirror 14 by holding the remnant cut of envelope 12 after removing toothpick 16.

In the figures and/or description herein, the following reference numerals have been mentioned:
numeral 10 denotes an oral hygiene kit, according to one embodiment of the invention;
numeral 12 denotes an envelope of kit 10;
numeral 14 denotes a mirror;
numeral 16 denotes at least one toothpick;
numeral 18 denotes a user's palm;
numeral 20 denotes a view reflected from mirror 14;
numeral 22 denotes a user;
numeral 28 denotes a first roller of enveloping material;
numeral 30 denotes a second roller of enveloping material;
numeral 32 denotes a mirror dispenser;
numeral 34 denotes a toothpicks dispenser;
numeral 36 denotes a soldering iron;
numeral 38 denotes a cutting machine; and
numeral 40 denotes a tearing edge.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. An oral hygiene kit, comprising:
at least one toothpick (16);
a mirror (14);
a transparent envelope (12), hygienically enveloping said at least one toothpick and said mirror,
thereby said at least one toothpick (16) and said transparent envelope (12) comprise together a handle for looking at said mirror (14), and
thereby said looking at said mirror (14) is applied through said transparent envelope (12), and
thereby said looking at said mirror (14) allows considering a one-time removal of said at least one toothpick (16) from said transparent envelope (12).

2. An oral hygiene kit according to claim 1, wherein:
said mirror is stiff;
a length and width of said mirror are greater than a length and width of said at least one toothpick;
thereby preventing a user from being jabbed by said toothpick before using said kit.

3. An oral hygiene kit according to claim 1, wherein said envelope is sealed, thereby keeping said mirror and said at least one toothpick under hygienic conditions until use.

4. An oral hygiene kit according to claim 1, wherein said mirror is elongated, and a width thereof is about 1 cm, thereby providing a sufficient viewing area.

5. An oral hygiene kit according to claim 1, wherein said mirror is flexible, thereby allowing bending thereof while holding the mirror in a user's palm, for widening a viewing area reflected from the mirror.

6. An oral hygiene kit according to claim 1, wherein a length of said mirror is less than about 8 cm, for allowing holding thereof in a user's palm.

7. An oral hygiene kit according to claim 1, wherein a width of said mirror is about between 1 and 2 cm, for providing a sufficient viewing area.

8. An oral hygiene kit according to claim 1, wherein said envelope is made of a member of a group comprising: paper, nylon, cellophane.

9. An oral hygiene kit according to claim 1, wherein said mirror is made of a member of a group comprising: coated glass, mirror wallpaper, tin foil, coated aluminum foil, plastic polymer, plastic polymer of DC FIX MIRROR, and so on.

10. An oral hygiene kit according to claim 1, wherein a length of said transparent envelope (12) is equal or slightly longer than a length of said at least one toothpick (16), for being used as a handle for said mirror (14).

11. An oral hygiene kit according to claim 1, wherein said transparent envelope (12) comprises at least one tearing edge (40), for further holding said mirror (14) by a remnant of said transparent envelope (12) after removing said at least one toothpick (16).

12. An oral hygiene kit according to claim 1, wherein an enveloping process thereof comprises the steps of:
dispensing a mirror (14) from a dispenser (32) thereof on a first foil from a first roller (28);
dispensing at least one toothpick (16) from a dispenser (34) thereof;
covering said mirror and said at least one toothpick (16) by a second foil from a second roller (30); and
soldering, by a soldering iron (36), the second foil to the first foil.
